(19) United States
(12) Patent Application Publication
(10) Pub. No.: US 2003/0097272 A1
(43) Pub. Date: May 22, 2003

(54) Method for the cleanup of contaminated sites

(76) Inventors: Richard D. Ellison, Coto de Caza, CA (US); Michael C. Salmon, Coto de Caza, CA (US); John H. Claussen, Madison, CT (US); Martin H. Dodd, Canton, CT (US); Michael O. Hill, Bethesda, MD (US)

Correspondence Address: COLLIER, SHANNON, SCOTT, PLLC, 3050 K STREET, NW, SUITE 400, WASHINGTON, DC, 20007, US

(21) Appl. No.: 10/108,547

(22) Filed: Mar. 29, 2002

Related U.S. Application Data
(60) Provisional application No. 60/288,485, filed on May 3, 2001.
(60) Provisional application No. 60/294,205, filed on May 29, 2001.

(51) Int. Cl. G06F 17/60

(52) U.S. Cl. 705/1

(57) ABSTRACT

The invention relates to methods for assuming, transferring, and/or sharing liability and/or financial risks and/or rewards associated with the cleanup of contaminated sites. More specifically, the present invention includes methods through which a Service Provider assumes statutory and/or contractual liability and/or otherwise shares the financial, legal, and/or other risks and/or rewards associated with the cleanup of environmentally contaminated sites. The Service Provider may pursue, catalyze, expand, or otherwise promote, increase, or expedite Potential Additional Revenue Sources associated with the site cleanup.

### CROSS REFERENCE TO RELATED PATENT APPLICATIONS

This application claims priority on U.S. Provisional Patent Application Serial No. 60/288,485, for Method for Effecting Fixed Price Environmental Liability Transfers for Superfund Sites and Other Contaminated Properties, filed May 3, 2001, and claims priority on U.S. Provisional Patent Application Serial No. 60/294,205, for Method for Effecting Fixed Price Environmental Liability Transfers for Superfund Sites and Other Contaminated Properties, filed May 29, 2001.

### FIELD OF THE INVENTION

The invention relates to methods for assuming, transferring, and/or sharing liability and/or financial risks and/or rewards associated with the cleanup of contaminated sites. More specifically, the present invention includes methods through which a Service Provider assumes statutory and/or contractual liability and/or otherwise shares the financial, legal, and/or other risks associated with the cleanup of environmentally contaminated sites.

### BACKGROUND OF THE INVENTION

The cleanup of contaminated sites remains an enormous problem in the United States. Regardless of whether a site is a Superfund site, a “Brownfield” site, a combination of the two, or some other type of contaminated site altogether, sites suffer from real or perceived barriers to cleanup, redevelopment, and/or other reuse. Continuing generation of hazardous wastes and hazardous substances in our economy, and identification of sites that were contaminated before the risks of contamination were known as they are today, have led to increased governmental activity at the federal, state, and local levels directed to the cleanup of these sites.

In 1980, Congress passed the Comprehensive Environmental Response, Compensation and Liability Act (CERCLA), better known as the Superfund Act. This law gives the federal government the authority to respond to chemical emergencies and to clean up contaminated sites. The Superfund Program was intended by Congress to address both short- and long-term risks, from toxic chemical spills and threats to the permanent cleanup of abandoned hazardous waste sites. The Superfund Program also provides the government authority to pursue those persons responsible for the release of hazardous waste and a trust fund to subsidize cleanup when no responsible parties can be identified.

Seven hundred thousand tons of hazardous waste are produced in America every day. In 1995 alone, over $670,000,000 was spent cleaning up hazardous waste, with hundreds of millions more spent on attorney fees, consultants, and other transaction costs. Historically, people were less aware of how dumping chemical waste might affect public health and the environment. On thousands of properties where such practices were intensive and/or continuous, the contamination was uncontrolled and led to many abandoned contaminated sites, such as abandoned warehouses and landfills.

The Superfund Program was established by Congress to locate, investigate, and clean up the worst sites nationwide. The United States Environmental Protection Agency (EPA) is tasked to administer the Superfund Program in cooperation with individual state and local governments as well as Indian tribes. EPA claims that, since its inception in 1980, the Superfund Program has fostered the cleanup of hundreds of hazardous waste sites nationwide. However, the actual cleanup of toxic sites is becoming unnecessarily expensive and it is taking years to remove the contamination.

Under the Superfund Program, parties responsible for the contamination are referred to as “potentially responsible parties” or “PRPs.” Rather than limit the scope of the present invention to only those persons who have been held liable as responsible parties under the Superfund statute specifically, the present inventors use the broader term “potentially responsible parties” or “PRPs” to refer to those persons in the zone of potential liability or responsibility for the cleanup of any contaminated site, whether or not under the Superfund statute itself. For purposes of this application, all responsible persons, including but not limited to potentially responsible parties under Superfund, are referred to as Potentially Responsible Parties (“PRPs”) to make it clear that the invention is not limited to Superfund applications or to situations in which liability has been established.

PRPs are required—by law, business, and/or ethics—to perform or finance the cleanup of contaminated sites. The number of PRPs required to do cleanups has continued to grow. When those responsible for contamination cannot be found or are unable to pay, EPA may use money from a trust fund, known as “the Superfund,” to finance the cleanup of the worst of these sites. Regardless of whether the Superfund is used, EPA is authorized to attempt to force or recover the cost of the cleanup by taking legal action, against PRPs. But as documented in Government Accounting Office (“GAO”) and numerous other reports, the EPA model is notorious for its inefficiencies in cost and its delays in action. See, e.g., GAO/RCED-00-22, January 2000; GAO/RCED-95-46, December 1994; GAO/RCED-98-221, August 1998; and GAO/RCED-97-211, September 1997, which are incorporated herein by reference in their entireties. An improved method, therefore, is needed in the industry to facilitate the cleanup of these sites and reduce the need for government funds and legal delays.

Moreover, the Superfund was previously financed through a tax on industry, and that tax was terminated several years ago. As a result, the Superfund trust fund is now almost completely out of money. See New York Times, at A1 (Feb. 24, 2000). This situation simply amplifies the need for an effective alternative to prior known methods of effecting cleanups and of pursuing potential additional sources of revenue to pay for the cleanup.

Brownfields are abandoned, idled, and/or under-used industrial, commercial, and other facilities where expansion or redevelopment may be barred, delayed, or simply complicated by real or perceived environmental contamination. The number of Brownfield sites has increased throughout the United States to where there are now literally hundreds of thousands of them. Brownfields typically remain undeveloped because of several critical unknowns, including but not limited to: the level of existing contamination on the sites; the cost to clean it up; the often vague notions of potential responsibility for that contamination; and the cost and time inefficiencies now associated with resolving the above factors and accomplishing the cleanup.

EPA and states, through what are often generally described as their Brownfields initiatives, endeavor to empower states, communities, and other stakeholders to work together in a timely manner to prevent, assess, safely clean up, and/or sustainably reuse Brownfields.

The liability and costs associated with the cleanup of Superfund, Brownfield, and other contaminated sites can be extensive. Potential liability extends to all PRPs, as does the expectation that the PRPs will pay the costs involved in cleanup. Generally speaking, PRPs may be selected from, but are not limited to, the group comprising any person who owned or owns the site, operated or operates the site, or sent or transported hazardous substances to the site for treatment or disposal.

Processes known prior to the creation of the present invention for PRPs to negotiate, litigate, perform, and/or manage the cleanup of Superfund, Brownfield, or other contaminated sites are widely considered expensive, inefficient, and unpredictable. In a typical case, for example, the government may sue one or more of the PRPs, and those PRPs, in turn, sue other PRPs. Those PRPs will spend substantial resources assessing, negotiating, and/or litigating with each other and/or with the government and/or with still other PRPs with regard to their respective liabilities and/or shares of responsibility. Enormous amounts of time and money are also spent in assessing, negotiating, and/or litigating the requirements of the cleanup, and in hiring, managing, and/or overseeing contractors to assess the needs and perform the cleanup.

Prior to the present invention, typically, a contractor was hired to clean up the site on a time-and-materials basis. Applicant is unaware of any method prior to the present invention through which persons who are not legally responsible for the cleanup (service providers)—such as, but not limited to, an environmental cleanup contractor, prospective developer, prospective purchaser, and/or others (hereafter collectively referred to as “Service Provider”)—assume full liability and/or effect cleanup of a contaminated site on any of the bases for which a patent is sought in this application. In particular, prior to the present invention, Applicant is not aware of any method for PRPs or non-PRPs (“Clients”) to: (a) have a Service Provider voluntarily assume full liability (statutory and/or contractual) for the cleanup of a site; and/or (b) share in any of several potential additional revenue sources associated with the cleanup efforts (e.g., pre-existing insurance polices, contribution from other PRPs, increased value of the property as a result of or in anticipation of the cleanup, increased property tax revenues, or other sources) (hereafter collectively referred to as “Potential Additional Revenue Sources”) as a means of financing, in whole or in part, the cleanup.

Under prior known methods, the cost of cleanup remains highly unpredictable and uncertain. Even though the PRPs and/or non-PRPs and the vendor may agree on an estimated cost for the cleanup, these costs often escalate due to: changes in the government's cleanup standards; the discovery of additional contamination; and/or weather, labor, geological, and/or other problems encountered.

Also, in the context of multi-party Superfund and other sites, methods prior to the present invention to effect the cleanup of a site also lead to extensive litigation and/or other high transaction costs between and/or among PRPs, and between and/or among PRPs and non-PRPS, as to their respective responsibility and liability. Costs often increase two- or three-fold over the costs that are actually spent cleaning up the site.

These problems make cleanup and the related litigation time-consuming and burdensome, and delay both the commencement and the completion of the cleanup. Moreover, even when the cleanup is done, the land is often left in a state that does little to reflect or promote its best next use. Consequently, prior to the present invention, there remains a substantial unmet need for an improved method for parties to effect the cleanup and reuse of contaminated sites. In particular, methods are needed that address the cleanup costs, litigation and/or other transactions costs, the liability and/or other risks for and financing of cleanup efforts, and/or the reuse and/or development of the site.

### OBJECTS OF THE INVENTION

It is therefore an object of the present invention to provide a method for a Service Provider to assume, and/or share in the regulatory (e.g., statutory) liability for the cleanup of a contaminated site.

It is another object of the present invention to provide a method for a Service Provider to contractually assume liability of a PRP, or to a non-liable party, for the cleanup of a contaminated site.

It is still another object of an embodiment of the present invention to provide a method for a Service Provider to share in the risks and/or rewards associated with the cleanup of a contaminated site.

It is yet another object of the present invention to provide a method for a Service Provider to share in the recovery of funds or other assets or asset improvements associated with the cleanup of a contaminated site.

Additional objects and advantages of the invention are set forth, in part, in the description that follows and, in part, will be apparent to one of ordinary skill in the art from the description and/or from the practice of the invention.

### SUMMARY OF THE INVENTION

Responsive to the foregoing challenges, Applicant has developed an improved method for cleaning up environmental contamination at a site involving one or more Clients, the method further comprising the step of: one or more persons assuming liability for the cleanup of the site, the liability selected from the group consisting of: full statutory liability; shared statutory liability; full contractual liability; shared contractual liability; and/or limited contractual liability.

According to an alternative preferred embodiment, an improved method for cleaning up environmental contamination at a site involving one or more Clients, the method further comprises the step of: assuming statutory liability for the cleanup of the site for at least one of the one or more Clients. The method may further comprise the step of assuming contractual liability for the cleanup of the site.

According to another alternative preferred embodiment, an improved method for cleaning up environmental contamination at a site involving one or more Clients, the method further comprises the step of: assuming statutory liability for the cleanup of the site for at least one of the one or more Clients for a fixed fee.

In yet another alternative preferred embodiment, an improved method for cleaning up environmental contamination at a site involving one or more Clients, the method further comprises the step of: sharing statutory liability for the cleanup of the site between a Service Provider and at least one of the one or more Clients.

According to another alternative preferred embodiment, an improved method for cleaning up environmental contamination at a site involving one or more Clients, the method further comprises the step of: sharing in one or more revenue sources associated with the cleanup of the site. The revenue sources may be selected from the group consisting of: the increased value of the property; contribution form third parties; insurance proceeds; proceeds from the use of the property; proceeds from the sale of the property; and increased property tax revenues.

In yet another alternative preferred embodiment, an improved method for cleaning up environmental contamination at a site involving one or more Clients, the method further comprises the step of: sharing savings achieved below a time-and-materials cost estimate between one or more Service Providers and one or more Clients. Alternatively, the method further comprises the step of: sharing costs incurred above a time-and-materials cost estimate between one or more Service Providers and one or more Clients. Alternatively, the method further comprises the step of: sharing the difference from a time-and-materials cost estimate between one or more Service Providers and one or more Clients, the difference selected from the group consisting of savings achieved below the time-and-materials costs estimate and costs incurred above the time-and-materials cost estimate.

The present invention is also directed to a process for cleaning up environmental contamination at a site involving one or more Clients, and comprising the step of financing the cleanup on a time-and-materials basis, the improvement comprising: assuming statutory liability from one or more of the Clients.

In an alternative preferred embodiment, a process for cleaning up environmental contamination at a site involving one or more Clients, and comprising the step of financing the cleanup on a time-and-materials basis, the improvement comprises: assuming statutory liability from one or more of the Clients and cleaning up the site on a basis other than time-and-materials.

In another alternative preferred embodiment, a process for cleaning up environmental contamination at a site involving one or more Clients, and comprising the step of financing the cleanup on a time-and-materials basis, the improvement comprises: assuming contractual liability from one or more of the Clients for a fixed fee.

According to yet another alternative preferred embodiment, a process for cleaning up environmental contamination at a site involving one or more Clients, and comprising the step of financing the cleanup on a time-and-materials basis, the improvement comprises: cleaning the site on a fixed fee basis.

In another alternative preferred embodiment, a process for cleaning up environmental contamination at a site involving one or more Clients, and comprising the step of financing the cleanup on a time-and-materials basis, the improvement comprises: cleaning the site on a basis other than time-and-materials.

According to yet another alternative preferred embodiment, a process for cleaning up environmental contamination at a site involving one or more Clients, and comprising the step of financing the cleanup on a time-and-materials basis, the improvement comprises: assuming liability from one or more of the Clients, using the sources of revenue associated with the cleanup to finance a portion of the cleanup, and cleaning up the site on a basis other than time-and-materials.

In another alternative preferred embodiment, a process for cleaning up environmental contamination at a site involving one or more Clients, and comprising the step of financing the cleanup on a time-and-materials basis, the improvement comprises: using the sources of revenue associated with the cleanup to help finance the cleanup.

In yet another alternative preferred embodiment, a process for cleaning up environmental contamination at a site involving one or more Clients, and comprising the step of financing the cleanup on a time-and-materials basis, the improvement comprises: assuming liability from one or more of the Clients and using the sources of revenue associated with the cleanup to help finance a portion of the cleanup. The revenue sources may be selected from the group consisting of: the increased value of the property; contribution form third parties; insurance proceeds; proceeds from the use of the property; proceeds from the sale of the property; and increased property tax revenues.

According to another alternative preferred embodiment, a process for cleaning up environmental contamination at a site involving one or more Clients, and comprising the step of financing the cleanup on a time-and-materials basis, the improvement comprises: using the increased property value associated with the cleanup to finance a portion of the cleanup and cleaning up the site on a basis other than time-and-materials.

It is to be understood that both the foregoing general description and the following detailed description are exemplary and explanatory only, and are not restrictive of the invention as claimed. The accompanying drawings, which are incorporated herein by reference, and which constitute a part of this specification, illustrate certain embodiments of the invention and, together with the detailed description, serve to explain the principles of the present invention.

### BRIEF DESCRIPTION OF THE DRAWINGS

In order to assist the understanding of this invention, reference will now be made to the appended drawings. The drawings are exemplary only and should not be construed as limiting the invention.

FIG. 1 is a flow chart of methods for cleaning up environmental contamination at a site according to preferred embodiments of the present invention.

### DETAILED DESCRIPTION OF THE PREFERRED EMBODIMENTS

Applicant has developed an improved method for the cleanup of a site in which one or more Clients—which clients may be single or multiple PRPs and/or single or multiple non-PRPs—may share or resolve their liability and/or cleanup cost risks for contamination at a site and/or use proceeds from potential additional revenue sources, such as pre-existing insurance policies, contribution from other PRPS, the increase in value of a site associated with the cleanup efforts, increased property tax revenue, and/or any other potential revenue sources (hereafter, collectively referred to as “Potential Additional Revenue Sources”) to finance all or a portion of the cleanup. PRP Clients may be selected from, but are not limited to, the group comprising any person or entity who owned or owns the site, operated or operates the site, sent or transported hazardous substances to the site for treatment or disposal, or are potentially liable for the cleanup costs for any other reason. Non-PRP Clients may be any other person or entity who is not liable for the cleanup of the site but who nevertheless wants it cleaned up (e.g., governments with a regulatory responsibility for cleanup, neighbors, or innocent owners of contaminated property). In a preferred embodiment, a Service Provider stands in the Client's shoes (either with the Client or instead of the Client) and fully performs the cleanup. The Service Provider may be a contractor, company, partnership, or any other suitable person or entity. The Service Provider may provide or obtain on behalf of all participating Clients indemnification as well as with additional, site-specific insurance to protect against cost increases (hereinafter, “cost-cap insurance”).

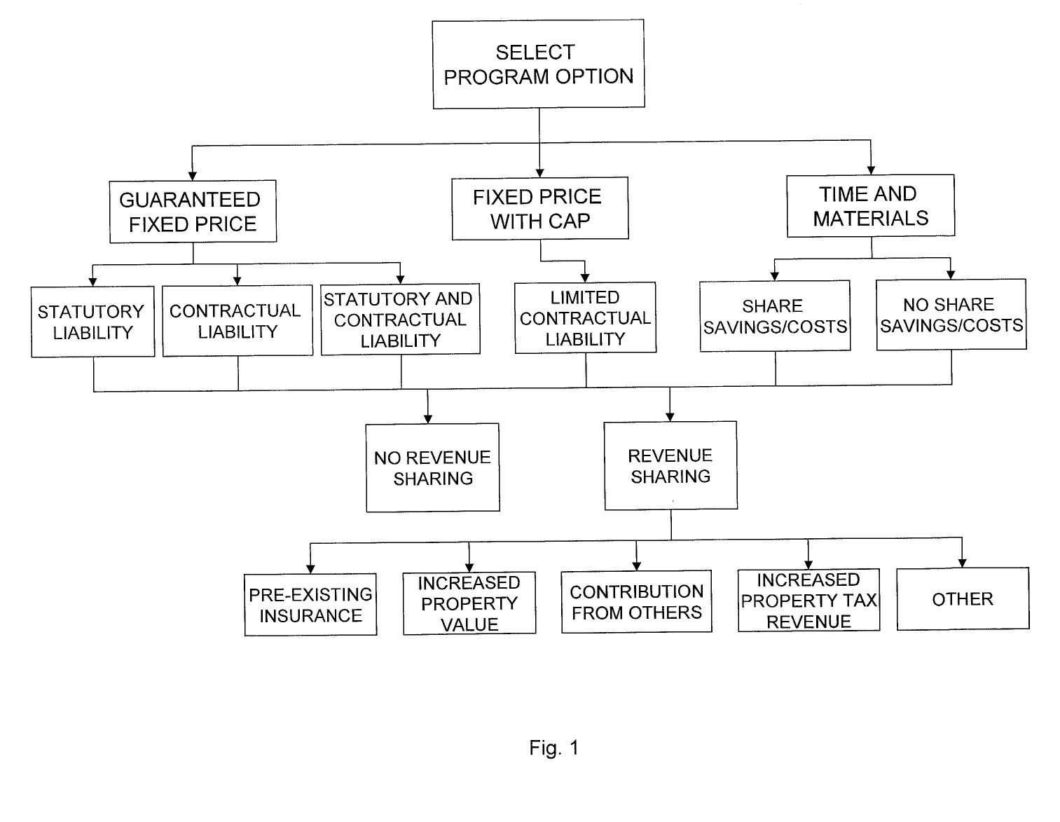

Alternatively, either in addition to or in lieu of the above, a Service Provider may contract with the Client(s) to share in any Potential Additional Revenue Sources associated with the cleanup of the site. The shared recovery feature of a preferred embodiment of the present invention is optional and therefore may be offered with or without the Service Provider's assumption, transfer, and/or sharing of liability or risk. These improved methods fall into basically three categories, as shown in FIG. 1, which can be used individually, or in combination, for the cleanup of a site.

Table 1 identifies various combination and variations of embodiments of the present invention.

TABLE 1

| Price For Cleanup | | Assumption of | Potential Additional |
|---|---|---|---|
| Costs | Client(s) | Liability | Revenue Sources |
| Fixed Price | Single or Multiple; | Assumption of Statutory | Pre-Existing Insurance; |
| | PRP and/or non-PRP | Liability; | |
| | | Assumption of | Increased Property |
| Fixed Price by Stage | | Contractual Liability to | Value; |
| of Cleanup; | | Extent of Statutory | |
| | | Liability of the PRP(s); | |
| Contingency; | | | Third Party Contribution; |
| Fee Based on | | Assumption of Statutory | Increased Property Tax |
| Milestones; | | and Contractual | Revenues |
| | | Liability; | |
| Time-and-materials, | | Limited Assumption of | Other Revenue Sources |
| but with shared | | Contractual Liability; | |
| savings/costs | | | |
| Time-and-materials | | Limited Assumption of | None |
| | | Contractual Liability | |
| | | (e.g., up to Limits of | |
| | | Client Payment Plus | |
| | | Pre-Existing Insurance | |
| | | or Other Funds); | |
| | | No Assumption of | |
| | | Liability | |

Based upon the elements depicted in Table 1, Applicant has identified certain examples of the invention that Applicant believes represent viable business models to support or finance cleanup efforts. Indeed, Applicant has already applied some of these methods to effect the cleanup of contaminated sites. See, e.g., State of Maine v. U.S. and Settling Nonfederal Defendants and TRC, No. 00-64-B-C (D. Me. May 30, 2000), which is incorporated herein by reference in its entirety, and is also described in Applicant's U.S. Provisional Patent Application Serial No. 60/288,485, filed May 3, 2001 and U.S. Provisional Patent Application Serial No. 60/294,205, filed May 29, 2001. Table 2 identifies certain preferred embodiments of the present invention as well as a description of a prior known method for comparison purposes.

TABLE 2

| | | | Type Or Extent Of | Potential Additional |
|---|---|---|---|---|
| | | | Liability Assumed | Revenue Sources |
| Type of Program | Cost of Program | Client(s) | By Service Provider | (Optional) |
| Guaranteed Fixed | Fixed Price | Single or Multiple; | Assumption Of | Pre-Existing |
| Price Program with | | PRP(s) and/or non- | Contractual Liability | Insurance; Increased |
| Assumption of | | PRP(s) | To Perform Cleanup | Property Value; |
| Statutory Liability | | | And/Or Assumption | Third-Party |
| | | | Of Statutory Liability | Contribution; |
| | | | To Perform Cleanup | Increased Property |
| | | | | Tax Revenues; |
| | | | | Other Shared |
| | | | | Recovery |
| Guaranteed Fixed | Fixed Price | Single or Multiple; | Assumption Of | Pre-Existing |
| Price Program with | | PRP(s) and/or non- | Contractual Liability | Insurance, Increased |
| Assumption of Full | | PRP(s) | | Property Value; |
| Contractual Liability | | | | Third-Party |
| | | | | Contribution; |
| | | | | Increased Property |
| | | | | Tax Revenues; |
| | | | | Other Shared |
| | | | | Recovery |
| Guaranteed Fixed | Fixed Price With Cap | Single or Multiple, | Limited Assumption | Pre-Existing |
| Price Program with | | PRP(s) and/or non- | Of Contractual | Insurance; Increased |
| Assumption of | | PRP(s) | Liability | Property Value; |
| Limited Contractual | | | | Third-Party |
| Liability (e.g. capped | | | | Contribution; |
| by funds Client(s) | | | | Increased Property |
| provide and/or | | | | Tax Revenues; |
| revenues from | | | | Other Shared |
| insurance and/or | | | | Recovery |
| other sources) | | | | |
| Time-And-Materials | Time-And-Materials | Single or Multiple; | None | Pre-Existing |
| With Shared | (lowered or raised) | PRP(s) and/or non- | | Insurance; Increased |
| Savings/Costs | | PRP(s) | | Property Value; |
| | | | | Third-Party |
| | | | | Contribution; |
| | | | | Increased Property |
| | | | | Tax Revenues; |
| | | | | Other Shared |
| | | | | Recovery |
| Time-And-Materials | Time-And-Materials | Single or Multiple; | None | Pre-Existing |
| With No Shared | | PRP(s) and/or non- | | Insurance; Increased |
| Savings/Costs | | PRP(s) | | Property Value; |
| | | | | Third-Party |
| | | | | Contribution; |
| | | | | Increased Property |
| | | | | Tax Revenues; |
| | | | | Other Shared |
| | | | | Recovery |
| Time-And-Materials | Time-And-Materials | Single or Multiple; | None | None |
| With No Shared | | PRP(s) and/or non- | | |
| Savings/Costs (prior | | PRP(s) | | |
| art) | | | | |

The examples of the present invention identified below and in Tables 1 and 2 are exemplary and illustrative only and are not intended to limit the invention as claimed to any particular embodiment or combination of embodiments.

With reference to FIG. 1 and Table 3, in a first alternative preferred embodiment of the present invention, the method for cleaning up a site involving one or more Clients comprises a Service Provider assuming full regulatory (e.g., statutory) liability for cleanup of the site for one or more of the contracting Clients. The Service Provider remains liable in perpetuity to perform the full cleanup and to maintain full compliance with government environmental cleanup standards.

The Service Provider's assumption of liability may be further assured and/or guaranteed in any of various ways. In preferred embodiments of the present invention, performance of the assumption of regulatory (e.g., statutory) liability may be further secured not only by an indemnity from the Service Provider but also by obtaining site-specific cost-cap insurance naming the Service Provider and/or the Clients and/or others (e.g., the government) as beneficiaries. The insurance policy covers and protects the Service Provider, the Clients and/or the government in the event any cost increases. In addition, the Service Provider preferably provides full coverage and/or indemnification for any and all costs that exceed the amount paid plus the funds available from, for example, the cost-cap insurance.

It will be apparent to persons of ordinary skill in the art that various modifications and variations could be made in the liability assumption and fees that are employed in the present invention without departing from the scope or spirit of the invention. For example, although the preferred embodiment is illustrated with respect to assumption of regulatory liability, alternative embodiments do not require the assumption of regulatory liability (e.g., it could be merely contractual to the Client(s)). Another embodiment may involve an assumption of both statutory and contractual liability. In addition, liability may be limited and/or shared between the Service Provider and the Client(s) and/or liability may not be shifted from the Client(s) at all. The cleanup may be insured up to an agreed amount to protect against cost overruns, and the services could be provided on a fixed fee, graduated fee, contingency fee, performance, or any other suitable basis. Thus, it is intended that the present invention cover all the variations and modifications of various liability assumption and fees that could be employed, provided they come within the scope of the present invention as claimed in the appended claims and their equivalents.

In a second alternative preferred embodiment of the present invention, the method for cleaning up a site involving one or more parties comprises cleaning up the site on other than a time-and-materials basis, such as, for example, on a fixed price, variable price, contingency, and/or other basis of financing the cleanup. (As used herein, the term time-and-materials refers to contracting in which the fee is based linearly or near-linearly on the amount of time spent in providing the services and the costs spent in providing materials).

It will be apparent to persons of ordinary skill in the art that various modifications and variations could be made in the basis for determining the cost structure for the cleanup according to the present invention, without departing from the scope or spirit of the invention. For example, the cleanup could be insured up to an agreed amount to protect against cost overruns, the cleanup could be provided on a fixed fee, graduated fee, contingency fee, performance, payment scale, milestone scale, time-and-materials, or any other basis. Thus, it is intended that the present invention cover all the variations and modifications of various fee structures that could be employed, provided they come within the scope of the present invention as claimed in the appended claims and their equivalents.

In a third alternative preferred embodiment, a Service Provider may undertake the cleanup on a time-and-materials basis, but with the Service Provider and Client(s) agreeing to share any savings achieved and/or costs incurred above or below a time-and-materials cost estimate for the cleanup. In this manner, the Service Provider and Client(s) may share risks and rewards associated with the cleanup. This embodiment may further include an agreement between the Service Provider and Client(s) to share in any recovery or increased value associated with the cleanup of the site. The recovery or value may be generated by any one or more of the Potential Additional Revenue Sources. Alternatively, the Service Provider and Client(s) may simply agree to proceed on a straightforward time-and-materials basis but to also share in any recovery of Potential Additional Revenue Sources.

In a fourth alternative preferred embodiment, the Service Provider may undertake the cleanup on a basis other than time-and-materials, such as an adjusted price for the labor, materials, and other costs required to perform the cleanup in return for the Service Provider's right to share in the receipt of any Potential Additional Revenue Sources.

It will be apparent to persons of ordinary skill in the art that various modifications and variations could be made in the methods of sharing or transferring financial risks and/or rewards of an embodiment of the present invention without departing from the scope or spirit of the invention. For example, the risks and rewards can arise from any Potential Additional Revenue Sources. In addition, the shared risks and/or rewards may be used in combination with other embodiment(s) of the present invention, including, but not limited to, full, limited, or shared statutory and/or contractual liability, and performed under a fixed, variable, graduated, contingency, performance, or a time-and-materials fee basis. Thus, it is intended that the present invention cover all the variations and modifications of liability, pricing, and shared risks and/or rewards that could be employed, provided they come within the scope of the present invention as claimed in the appended claims and their equivalents.

TABLE 3

| | | | | | | POTENTIAL ADDITIONAL REVENUE SOURCES FOR POSSIBLE | | | | |
|---|---|---|---|---|---|---|---|---|---|---|
| | | | | | | SHARING BETWEEN SERVICE PROVIDER AND CLIENT(S) | | | | |
| | | | | | | | | | | Other |
| | | CLIENT(S) | | | | | | Increased | Contribution | (e.g., increased |
| | | Single | | Multiple | | | Pre-Existing | Property | From | property |
| SERVICE PROVIDER | | PRP | Non-PRP | PRP | Non-PRP | None | Insurance | Value | Third Parties | tax revenues) |
| PROGRAM | | (1) | (2) | (3) | (4) | (a) | (b) | (c) | (d) | (e) |
| Guaranteed | Statutory | Yes | Yes | Yes | Yes | Optional | Optional | Optional | Optional | Optional |
| Fixed Price | Liability (A) | | | | | | | | | |
| I | Contractual | Yes | Yes | Yes | Yes | Optional | Optional | Optional | Optional | Optional |
| | Liability (B) | | | | | | | | | |
| | Statutory And | Yes | Yes | Yes | Yes | Optional | Optional | Optional | Optional | Optional |
| | Contractual | | | | | | | | | |
| | (C) | | | | | | | | | |
| Fixed Price For Assumption | | Prior Art | Yes | Yes | Yes | Optional | Optional | Optional | Optional | Optional |
| Of Contractual Liability, | | Unless | | | | | | | | |
| But Capped By Amount Of | | Combine | | | | | | | | |
| Funds Provided And | | With | | | | | | | | |
| Insurance Paid For By | | Optional | | | | | | | | |
| Client(s) | | Revenue | | | | | | | | |
| II | | Sharing | | | | | | | | |
| | | (b-e) | | | | | | | | |
| Time And | Share | Yes | Yes | Yes | Yes | Optional | Optional | Optional | Optional | Optional |
| Materials | Savings And | | | | | | | | | |
| III | Costs Above/ | | | | | | | | | |
| | Below Price | | | | | | | | | |
| | Estimate Of | | | | | | | | | |
| | Time-And- | | | | | | | | | |
| | Material Cost | | | | | | | | | |
| | (A) | | | | | | | | | |
| | No Sharing of | Prior Art. | Prior Art: | Prior Art: | Prior Art: | Prior Art: | Optional | Optional | Optional | Optional |
| | Savings Or | Unless | Unless | Unless | Unless | Assume | | | | |
| | Costs | Combine | Combine | Combine | Combine | No | | | | |
| | (Straight | With | With | With | With | Liability | | | | |
| | Time-And- | Sharing | Sharing | Sharing | Sharing | And No | | | | |
| | Material Cost) | (b-e) | (b-e) | (b-e) | (b-e) | Sharing | | | | |
| | (B) | | | | | | | | | |

Examples 1-5 of the present invention are exemplary and illustrative only and are not intended to limit the invention as claimed to any particular embodiment or combination of embodiments.

### EXAMPLE 1

For example, with respect to Program I, a method to provide Client(s) with a guarantee that the Service Provider will clean up a contaminated site for a fixed price, which guarantee is backed up by a Service Provider assuming full statutory liability and/or contractual liability to complete the cleanup to where the government requires no further cleanup action, is shown in its various forms by Cells I(A-C)(1-4) of Table 3. By further way of example, a full transfer and/or assumption of liability may take place between thousands of PRPs and a single Service Provider, in which the Service Provider obtains insurance to guarantee the cleanup of the site, as in State of Maine v. U.S. and Settling Nonfederal Defendants and TRC, No. 00-64-B-C (D. Me. May 30, 2000), which is incorporated herein by reference in its entirety. An optional variant of this example is for a Service Provider and Client(s) to agree to share any potential revenues obtained from any one or more of the Alternative Revenue Sources. In accordance with this example, these revenue sharing options are reflected in any one or more of the Cells included under Cells I(A-C)(1-4)(b-e) of Table 3. It will be known to persons of ordinary skill in the art that various other combinations could be employed, provided they come within the scope of the present invention as claimed in the appended claims and their equivalents.

### EXAMPLE 2

For example, with respect to Program II, providing Client(s) with a relatively certain price to clean up a contaminated site, which price would reflect funds initially provided by the Client (the “Initial Funds”), plus funds from any proceeds from insurance funded by the Client(s), is shown in its various forms by Cells II(2-4) of Table 3. However, a Service Provider's contractual obligations and liabilities would be limited by the amount of the Initial Funds together with any proceeds from such insurance. An optional variant of this example is for a Service Provider and Client(s) to agree to share any potential revenues obtained from any one or more of the Potential Additional Revenue Sources. In accordance with this example, these revenue sharing options are reflected in any one or more of the cells included under Cells II(1-4)(b-e) of Table 3. It will be known to persons of ordinary skill in the art that various other combinations could be employed, provided they come within the scope of the present invention as claimed in the appended claims and their equivalents.

### EXAMPLE 3

For example, with respect to Program III(A), a program that provides Client(s) with an estimate of costs for cleaning up a contaminated site, but with a mechanism through which a Service Provider and Client(s) share incentives for cost reduction and cost avoidance by sharing savings achieved below the cost estimate and also sharing costs incurred above the cost estimate, is shown by Cells III(A) of Table 3. An optional variant of this example is for a Service Provider and Client(s) to agree to share any potential revenues obtained from any one or more of the Potential Additional Revenue Sources. According to this example, these revenue sharing options are reflected in any one or more of the Cells included under Cells III(A)(1-4)(b-e) of Table 3. It will be known to persons of ordinary skill in the art that various other combinations could be employed, provided they come within the scope of the present invention as claimed in the appended claims and their equivalents.

### EXAMPLE 4

For example, with respect to Program III(B), providing Client(s) who choose to pay for a site cleanup on a time-and-materials basis—and with no sharing of liabilities or risks associated with the cleanup—but with a sharing of any potential revenues obtained from other sources comes within Cells III(B) of Table 3. Revenue from other sources may include any one or more of the Potential Additional Revenue Sources. According to this example, these revenue sharing options are reflected in any one or more of the cells included under III(B)(1-4)(b-e) of Table 3. It will be known to persons of ordinary skill in the art that various other combinations could be employed, provided they come within the scope of the present invention as claimed in the appended claims and their equivalents.

### EXAMPLE 5

Example 5 applies the invention to the bankruptcy context, in which one or more of the Clients is bankrupt. Example 5 would fit within any of the programs described in Table 3.

We claim:

1. An improved method for cleaning up environmental contamination at a site involving one or more Clients, the method further comprising the step of: one or more persons assuming liability for the cleanup of the site, said liability selected from the group consisting of: full statutory liability; shared statutory liability; full contractual liability; shared contractual liability; and limited contractual liability.

2. An improved method for cleaning up environmental contamination at a site involving one or more Clients, the method further comprising the step of: assuming statutory liability for the cleanup of the site for at least one of said one or more Clients.

3. The method according to claim 2, further comprising the step of assuming contractual liability for the cleanup of the site.

4. An improved method for cleaning up environmental contamination at a site involving one or more Clients, the method further comprising the step of: assuming statutory liability for the cleanup of the site for at least one of said one or more Clients for a fixed fee.

5. An improved method for cleaning up environmental contamination at a site involving one or more Clients, the method further comprising the step of: sharing statutory liability for the cleanup of the site between a Service Provider and at least one of said one or more Clients.

6. An improved method for cleaning up environmental contamination at a site involving one or more Clients, the method further comprising the step of: sharing in one or more revenue sources associated with the cleanup of the site.

7. The method according to claim 6, wherein said revenue sources are selected from the group consisting of: the increased value of the property; contribution from third parties; insurance proceeds; proceeds from the use of the property; proceeds from the sale of the property; and increased property tax revenues.

8. An improved method for cleaning up environmental contamination at a site involving one or more Clients, the method further comprising the step of: sharing savings achieved below a time-and-materials cost estimate between one or more Service Providers and one or more Clients.

9. An improved method for cleaning up environmental contamination at a site involving one or more Clients, the method further comprising the step of: sharing costs incurred above a time-and-materials cost estimate between one or more Service Providers and one or more Clients.

10. An improved method for cleaning up environmental contamination at a site involving one or more Clients, the method further comprising the step of: sharing the difference from a time-and-materials cost estimate between one or more Service Providers and one or more Clients, said difference selected from the group consisting of savings achieved below said time-and-materials costs estimate and costs incurred above said time-and-materials cost estimate.

11. In a process for cleaning up environmental contamination at a site involving one or more Clients, and comprising the step of financing the cleanup on a time-and-materials basis, the improvement comprising: assuming statutory liability from one or more of the Clients.

12. In a process for cleaning up environmental contamination at a site involving one or more Clients, and comprising the step of financing the cleanup on a time-and-materials basis, the improvement comprising: assuming statutory liability from one or more of the Clients and cleaning up the site on a basis other than time-and-materials.

13. In a process for cleaning up environmental contamination at a site involving one or more Clients, and comprising the step of financing the cleanup on a time-and-materials basis, the improvement comprising: assuming contractual liability from one or more of the Clients for a fixed fee.

14. In a process for cleaning up environmental contamination at a site involving one or more Clients, and comprising the step of financing the cleanup on a time-and-materials basis, the improvement comprising: cleaning the site on a fixed fee basis.

15. In a process for cleaning up environmental contamination at a site involving one or more Clients, and comprising the step of financing the cleanup on a time-and-materials basis, the improvement comprising: cleaning the site on a basis other than time-and-materials.

16. In a process for cleaning up environmental contamination at a site involving one or more Clients, and comprising the step of financing the cleanup on a time-and-materials basis, the improvement comprising: assuming liability from one or more of the Clients, using the sources of revenue associated with the cleanup to finance a portion of the cleanup, and cleaning up the site on a basis other than time-and-materials.

17. In a process for cleaning up environmental contamination at a site involving one or more Clients, and comprising the step of financing the cleanup on a time-and-materials basis, the improvement comprising: using the sources of revenue associated with the cleanup to help finance the cleanup.

18. In a process for cleaning up environmental contamination at a site involving one or more Clients, and comprising the step of financing the cleanup on a time-and-materials basis, the improvement comprising: assuming liability from one or more of the Clients and using the sources of revenue associated with the cleanup to help finance a portion of the cleanup.

19. The process according to claim 18, wherein said revenue sources are selected from the group consisting of: the increased value of the property; contribution form third parties; insurance proceeds; proceeds from the use of the property; proceeds from the sale of the property; and increased property tax revenues.

20. In a process for cleaning up environmental contamination at a site involving one or more Clients, and comprising the step of financing the cleanup on a time-and-materials basis, the improvement comprising: using the increased property value associated with the cleanup to finance a portion of the cleanup and cleaning up the site on a basis other than time-and-materials.
